(19) United States
(12) Patent Application Publication
(10) Pub. No.: US 2005/0274825 A1
(43) Pub. Date: Dec. 15, 2005

(54) Fire-hose nozzle with constant fluid flow

(75) Inventor: Jean-Francois Seguin, Bar sur Aube (FR)

Correspondence Address: CASELLA & HESPOS, 274 MADISON AVENUE, NEW YORK, NY, 10016, US

(73) Assignee: ST.-MIHIEL S.A.S., Paris (FR)

(21) Appl. No.: 11/150,393

(22) Filed: Jun. 9, 2005

(30) Foreign Application Priority Data
Jun. 11, 2004 (FR) 04 06316

(51) Int. Cl. B67D 5/08; B05B 7/02; B05B 9/01; B05B 1/30; B05B 15/08

(52) U.S. Cl. 239/525; 239/569; 239/587.1

(57) ABSTRACT

A fire-hose nozzle with a body (1) having a first end intended to be connected to a source of fluid under pressure and a second end supporting a hollow head (3) in which are provided a tube (8) and a stem (9) extending coaxially in the tube. The stem supports at its end situated opposite the body (1) an end-piece (10) delimiting with the tube an adjustable jet (11) intended to give passage to the fluid passing through the body and the hollow head. A regulator (14) is provided for automatically varying the dimensions of the jet (11) so that the fluid flow exiting therefrom remains constant irrespective of the pressure of the fluid.

### BACKGROUND OF THE INVENTION

1. Field of the Invention

The present invention relates to a fire-hose nozzle comprising a body having a first end intended to be connected to a source of fluid under pressure and a second end supporting a hollow head in which are provided a tube and a stem extending coaxially in the tube, the stem supporting at its end situated opposite the body an end-piece delimiting with the tube an adjustable jet intended to give passage to the fluid passing through the body and the hollow head.

2. Description of the Related Art

Current fire-hose nozzles have either a fixed or adjustable opening or are automatic.

In fixed opening nozzles, the dimensions of the jet are defined once and for all whereas in adjustable opening nozzles, the user can modify the dimensions of the jet to suit the power of the supply fluid which is usually water.

When the power of the fluid supplying these nozzles undergoes a variation, the latter systematically causes a variation in the fluid flow passing through the jet.

When the flow through the jet diminishes significantly, the quantity of fluid sprayed cannot properly protect the user against the phenomena of backdraft and flashover.

In automatic nozzles, the supply fluid varies the dimensions of the jet to suit its power in order to keep the internal pressure at a constant regulation value.

However, when the internal pressure of the fluid does not reach this value, for example when using a nozzle in the upper floors of an apartment building, the fluid flow passing through the jet here again risks becoming insufficient to properly protect the user against the phenomena of backdraft and flashover.

### SUMMARY OF THE INVENTION

The present invention proposes to remedy the disadvantage presented hereinabove and, to do so, its subject is a fire-hose nozzle having the structure mentioned in the first paragraph hereinabove and which comprises regulation means for automatically varying the dimensions of the jet so that the fluid flow exiting therefrom remains constant irrespective of the pressure of the fluid.

The risks of the firefighters being injured by phenomena of backdraft and flashover can now be reduced significantly.

Specifically, since the fluid exits the nozzle jet with a constant flow, even when the pressure of the fluid diminishes in the action location, the quantity of fluid sprayed remains constant.

The seriousness of the effects of the phenomena of backdraft and flashover may therefore be thus greatly reduced.

According to a first embodiment, the tube is mounted slidingly in the hollow head while the stem is fixed, the regulation means being designed to exert on the tube a force opposite to that of the fluid passing through and capable of moving said tube in the direction corresponding to an increase in the dimensions of the jet.

Thus the regulation means adapt the position of the tube so as to reduce the dimensions of the jet when the fluid pressure increases and to increase these dimensions when the fluid pressure reduces.

It should be noted here that, when the nozzle is not working, the dimensions of the jet are maximal.

Preferably, the regulation means comprise an elastic member situated in a cavity delimited by two annular collars extending coaxially and supported respectively by the tube and the head.

In this particular embodiment, the tube collar may advantageously be adjacent to the second end of the body and extend radially outward while the head collar may advantageously extend radially inward, at a greater distance from the second end of the body than the tube collar.

Furthermore, the elastic member is preferably made of elastomer.

According to a second embodiment, the tube and the stem are fixed, the regulation means being designed to exert on the end-piece a force opposite to that of the fluid passing through and capable of modifying the size of said end-piece in the direction corresponding to an increase in the dimensions of the jet.

The output flow here again remains constant irrespective of the pressure of the supply fluid. Specifically, the regulation means adapt the size of the end-piece so as to reduce the dimensions of the jet when the pressure of the fluid increases and to increase these dimensions when the pressure of the fluid diminishes.

Preferably, the regulation means comprise a deformable element covering the face of the end-piece which is turned toward the interior of the head, the deformable element being extendable radially under the action of the fluid passing through.

It will be specified here that the deformable element is preferably made of elastomer.

Two embodiments of the present invention will be described hereinafter as nonlimiting examples with reference to the appended drawings.

### BRIEF DESCRIPTION OF THE DRAWINGS

FIG. 1 is a view in perspective with cutaway of a fire-hose nozzle according to the invention.

FIG. 2 is a side view in partial section of the nozzle visible in FIG. 1.

FIG. 3 is a diagram representing the tube, the stem and the end-piece of another fire-hose nozzle according to the invention.

### DETAILED DESCRIPTION OF THE PREFERRED EMBODIMENTS

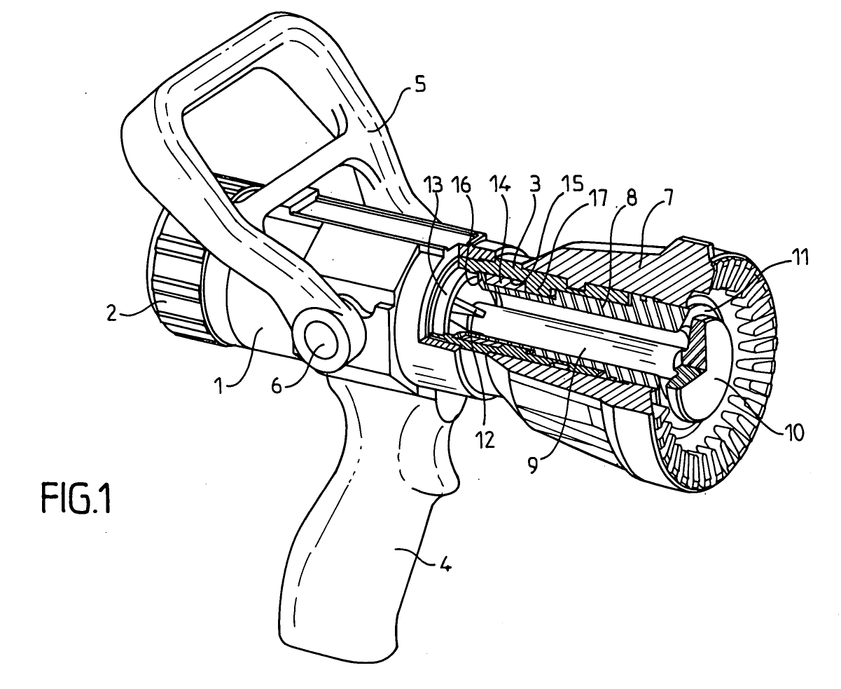

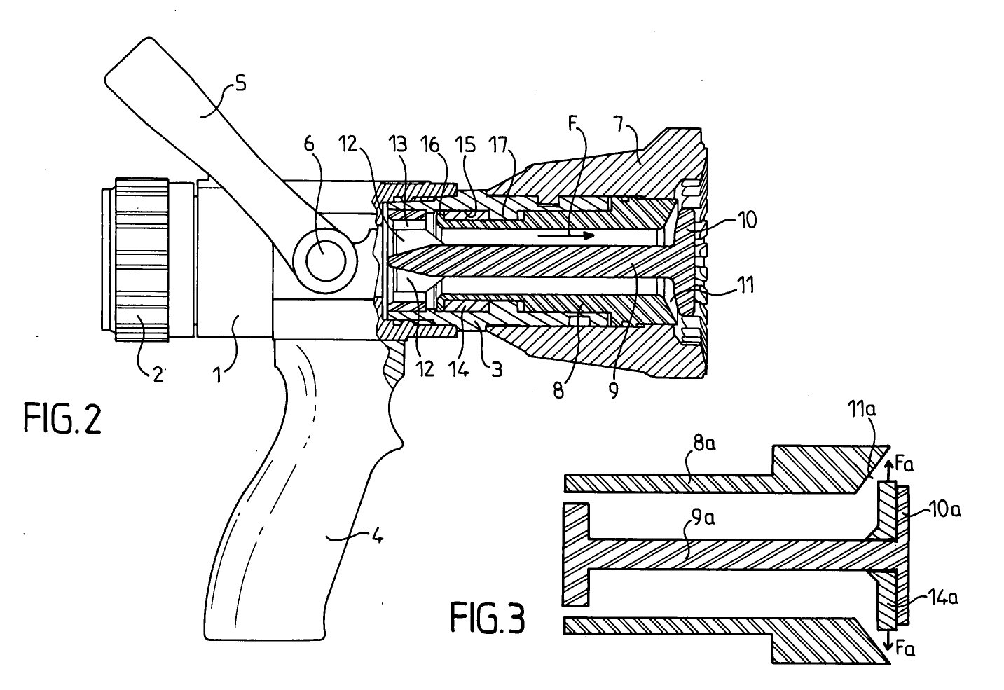

The fire-hose nozzle that can be seen in FIGS. 1 and 2 is a handheld nozzle intended to be held by the user during its operation.

It comprises a body 1 whose rear end is provided with a rotating connector 2 intended to be connected to a water supply pipe not shown, and whose front end supports a hollow head 3.

The body 1 comprises a grab handle 4 at its bottom part and an operating handle 5 at its top part.

The operating handle 5, which is U-shaped, is articulated on a shaft 6 perpendicular to the grab handle 4 and actuates a tap situated in the body 1 when the user causes it to pivot on the shaft 6.

The hollow head 3 supports, on the outer surface of its front part, a water effect selector 7 which the user must rotate on its shaft to modify, as required, the shape of the water jet exiting the nozzle.

A tube 8 and a stem 9 extending coaxially in the tube 8 are placed inside the head 3.

The tube 8 is mounted slidingly in the head 3 while the stem 9 is fixed.

At its front end, the stem 9 supports an end-piece 10 whose periphery is surrounded by the front part of the water effect selector 7 and which delimits with the front end of the tube 8 an adjustable jet 11 intended to give passage to the water passing through the body 1 and the hollow head 3 of the nozzle.

At its rear end, the stem 9 is provided with radial lugs 12 supporting a ring 13, the lugs and the ring being intended to rectify the flow of water reaching the head 3.

The fire-hose nozzle that has just been described also comprises regulation means 14 intended to automatically vary the dimensions of the jet 11 so that the water flow exiting the latter remains constant irrespective of the pressure of the water passing through.

In the embodiment shown, the regulation means 14 comprise an elastic member situated in a cavity 15 delimited by two annular collars 16, 17 extending coaxially and supported respectively by the tube 8 and the head 3.

The collar 16 is provided at the rear end of the tube 8 and extends radially outward while the collar 17 is situated in front of the collar 16 and protrudes on the internal surface of the head 3, radially inward.

In the example shown, the elastic member consists of a cylindrical ring made of elastomer, but it goes without saying that it could have any other shape and be made of any other material.

When the water is passing through the nozzle, it comes up against the rear end of the tube 8 and exerts thereupon a force directed in the direction of the arrow F in FIG. 2.

Under the action of this force, the tube 8 is acted upon in the direction of the end-piece 10 thus allowing the jet 11 to have predetermined dimensions and the elastic member 14 to be compressed between the tube 8 and the hollow head 3.

When the pressure of the water passing through increases, the action of the tube 8 in the direction of the arrow F increases and causes a reduction in the dimensions of the jet 11 and an increase in the compression of the elastic member.

Conversely, when the pressure of the water passing through diminishes, the action of the tube 8 in the direction of the arrow F diminishes while the elastic member expands causing an increase in the dimensions of the jet 11.

It is naturally sufficient to judiciously choose the elastic member 14 so that the dimensions of the jet 11 vary so that the water flow exiting the latter remains constant irrespective of the water pressure.

The tube 8a, the stem 9a and the end-piece 10a shown schematically in FIG. 3 form part of the internal structure of a variant embodiment of the fire-hose nozzle described with reference to FIGS. 1 and 2 and correspond respectively to the tube 8, the stem 9 and the end piece 10 of this nozzle.

In this variant, the tube 8a and the stem 9a are fixed while the regulation means 14a are designed to exert on the end piece 10a a force opposite to that of the water and capable of modifying the size of the latter in the direction corresponding to an increase of the jet 11a.

In the embodiment shown in FIG. 3, the regulation means 14a consist of a deformable element covering the internal face of the end piece 10a and made of a material that can expand radially under the action of the water passing through, this material preferably being made of elastomer.

When the water passes through the nozzle according to the variant embodiment as shown in FIG. 3, it comes up against the deformable element 14a and exerts thereon a radial force directed in the direction of the arrows Fa in FIG. 3.

Under the action of these forces, the deformable element 14a is stretched in the direction of the tube 8a thus allowing the jet 11a to have predetermined dimensions.

When the pressure of the water passing through increases, the extension of the deformable element 14a in the direction of the arrows Fa increases and is accompanied by a diminution of the dimensions of the jet 11a.

Conversely, when the pressure of the water passing through diminishes, the deformable element 14a contracts and thus allows an increase in the dimensions of the jet 11a.

It is naturally sufficient to judiciously choose the deformable element 14a so that the dimensions of the jet 11a vary such that the water flow exiting the latter remains constant irrespective of the pressure of the water.

1. A fire-hose nozzle comprising a body having a first end intended to be connected to a source of fluid under pressure and a second end supporting a hollow head in which are provided a tube and a stem extending coaxially in the tube, the stem supporting at its end situated opposite the body an end-piece delimiting with the tube an adjustable jet intended to give passage to the fluid passing through the body and the hollow head, which comprises regulation means for automatically varying the dimensions of the jet so that the fluid flow exiting therefrom remains constant irrespective of the pressure of the fluid.

2. The fire-hose nozzle of claim 1, wherein the tube is mounted slidingly in the hollow head while the stem is fixed, the regulation means being designed to exert on the tube a force opposite to that of the fluid passing through and capable of moving said tube in the direction corresponding to an increase in the dimensions of the jet.

3. The fire-hose nozzle of claim 2, wherein the regulation means comprise an elastic member situated in a cavity delimited by two annular collars extending coaxially and supported respectively by the tube and the head.

4. The fire-hose nozzle of claim 3, wherein the tube collar is adjacent to the second end of the body and extends radially outward while the head collar extends radially inward, at a greater distance from the second end of the body than the tube collar.

5. The fire-hose nozzle of claim 4, wherein the elastic member is made of elastomer.

6. The fire-hose nozzle of claim 3, wherein the elastic member is made of elastomer.

7. The fire-hose nozzle of claim 1, wherein the tube and the stem are fixed, the regulation means being designed to exert on the end-piece a force opposite to that of the fluid passing through and capable of modifying the size of said end-piece in the direction corresponding to an increase in the dimensions of the jet.

8. The fire-hose nozzle of claim 7, wherein the regulation means comprise a deformable element covering the face of the end-piece which is turned toward the interior of the head, the deformable element being extendable radially under the action of the fluid passing through.

9. The fire-hose nozzle of claim 8, wherein the deformable element is made of elastomer.
